(19) United States
(12) Patent Application Publication
(10) Pub. No.: US 2016/0319964 A1
(43) Pub. Date: Nov. 3, 2016

(54) EXPANDABLE AND CONTRACTIBLE HOSE ASSEMBLY HAVING THREE WAY VALVE

(71) Applicant: GE SUN SUNG, Mission Viejo, CA (US)

(72) Inventor: GE SUN SUNG, Mission Viejo, CA (US)

(21) Appl. No.: 14/698,164

(22) Filed: Apr. 28, 2015

(51) Int. Cl. F16L 11/12; F16L 11/04; F16K 11/02; F16L 11/02

(52) U.S. Cl. CPC F16L 11/12; F16L 11/02; F16L 11/04; F16K 11/02

(57) ABSTRACT

An expandable and contractible hose assembly includes a hose and a three way valve. The hose has a first end, a second end, and a fluid channel in which the fluid channel is constructed for transporting a fluid material from the first end to the second end. The three way valve is attached to the first end and the three way valve has a first port, a second port, a third port and a handle. The hose is constructed in that the hose longitudinally expands when there is a sufficiently increased fluid pressure in the fluid channel and the hose longitudinally contracts when there is a sufficiently decreased fluid pressure in the fluid channel.

### FIELD OF THE INVENTION

The present invention relates to an expandable and contractible hose assembly having a three way valve and, more particularly, to an expandable and contractible hose assembly having a three way valve in which the three way valve is constructed to be detachably attached to a faucet.

### BACKGROUND OF THE INVENTION

Hoses are used to carry fluids such as water, and conventional garden hoses are used to water garden. However, such garden hoses have an inconvenient storage problem when not in use. Garden hoses may be reeled in and stored at some place, or they may be left on the ground. To overcome this problem, expandable and contractible hoses have been developed.

U.S. Pat. No. 8,291,941 discloses an expandable and contractible hose. The hose automatically expands longitudinally and automatically expands laterally upon the application of a fluid pressure within the hose. Upon release of the fluid pressure within the hose, the hose automatically contacts to a contacted condition. The hose comprises an expandable inner tube made from an elastic material and an outer tube made from a non-elastic material.

U.S. Pat. Nos. 8,291,942 and 8,479,776 disclose an expandable and contractible hose similar to the one disclosed in U.S. Pat. No. 8,291,941. The outer tube is positioned around the outer circumference of the inner tube and secured to the inner tube only at the ends.

For these expandable and contractible hoses, one end of the hose is connected to a faucet and the other end to a spray nozzle. When in use, the hose considerably expands, and after using it, water remaining in the hose needs to be discharged so that the hose can contract and be stored.

However, discharging water remaining in the hose is cumbersome and takes a rather long time. In addition, it is each for the water being discharge to splash all over the ground, making it dirty.

The hoses disclosed in U.S. Pat. Nos. 8,291,941, 8,291,942 and 8,479,776 contract automatically once the spray nozzle is open so that water can be discharged therethrough. However, which the water is being discharged, the hose twists and turns on the ground and splashes water all over the ground.

Therefore, to solve the above problems, there is an expandable and contractible hose assembly having a three way valve in which the three way valve is constructed to be detachably attached to a faucet. This invention is directed to solve these problems and satisfy the long-felt need.

### SUMMARY OF THE INVENTION

The present invention contrives to solve the disadvantages of the prior art. The present invention provides an expandable and contractible hose assembly having a three way valve in which the three way valve is constructed to be detachably attached to a faucet. After using the hose, a user can discharge water in the hose simply by turning the handle of the three way valve so that the water can be discharged through a third port of the three way valve.

The object of the present invention is to provide an expandable and contractible hose assembly, having a hose and a three way valve. The hose has a first end, a second end, and a fluid channel in which the fluid channel is constructed for transporting a fluid material from the first end to the second end. The three way valve is attached to the first end and the three way valve has a first port, a second port, a third port and a handle. The hose is constructed in that the hose longitudinally expands when there is a sufficiently increased fluid pressure in the fluid channel and the hose longitudinally contracts when there is a sufficiently decreased fluid pressure in the fluid channel.

Another object of the present invention is to provide an expandable and contractible hose assembly, having a hose and a three way valve. The hose has a first end, a second end, and a fluid channel in which the fluid channel is constructed for transporting a fluid material from the first end to the second end. The three way valve is attached to the first end and the three way valve has a first port, a second port, a third port and a handle. The three way valve has two port connections, a first port connection and a second port connection, and the handle changes port connections between the first port connection and the second port connection. The first port connection is defined as a port connection between the first port and the second port so that fluid can flow between the first and second ports and the second port connection is defined as a port connection between the first port and the third port so that fluid can flow between the first and third ports. In the first port connection, the three way valve blocks the third port to prevent fluid from flowing to or from the third port, and in the second port connection, the three way valve blocks the second port to prevent fluid from flowing to or from the second port.

The advantages of the present invention are: (1) the hose of the present invention is very convenient to discharge water in the hose by using the three way valve; (2) by using automatically contracting hose, the hose of the present invention can automatically discharge water in the hose; (3) the three way valve of the present invention is attached to a faucet and thus, the water in the hose can be discharged through a fixed route of the three way valve—in other words, the water does not splash all over the ground; and (4) the water in the hose can be discharged through the three way valve and stored, for example, in a bucket, and then, it can be re-used for other purposes;

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 shows a conventional expandable and contractible hose according to the prior art;

FIG. 2 shows an expandable and contractible hose assembly according to one embodiment of the present invention;

FIG. 3 shows the hose assembly of FIG. 2 being attached to a faucet and a spray nozzle;

FIG. 4 shows the hose assembly of FIG. 3 with a handle of a three way valve turned;

FIG. 5 shows elements of an expandable and contractible hose assembly according to another embodiment of the present invention;

FIG. 6 shows the elements of FIG. 5 being attached to each other;

FIG. 7 shows the elements of FIG. 5 being attached to each other with a handle of a three way valve turned;

FIG. 8 shows a bottom view of the three way valve;

FIG. 9(a) shows a side view of the three way valve;

FIG. 9(b) shows another side view of the three way valve with the handle turned;

FIG. 10(a) shows a schematic diagram showing water flow when the hose is in use;

FIG. 10(b) shows a schematic view diagram water flow when water in the hose is discharged after using the hose;

FIG. 11(a) shows the expandable and contractible hose assembly of the present invention discharging water to a watering can; and

FIG. 11(b) shows the expandable and contractible hose assembly of the present invention discharging water to a flower bed.

### DETAILED DESCRIPTION EMBODIMENTS OF THE INVENTION

Reference will now be made in detail to the preferred embodiments of the present invention, examples of which are illustrated in the accompanying drawings, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention.

Also, as used in the specification including the appended claims, the singular forms “a”, “an”, and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about”, it will be understood that the particular value forms another embodiment.

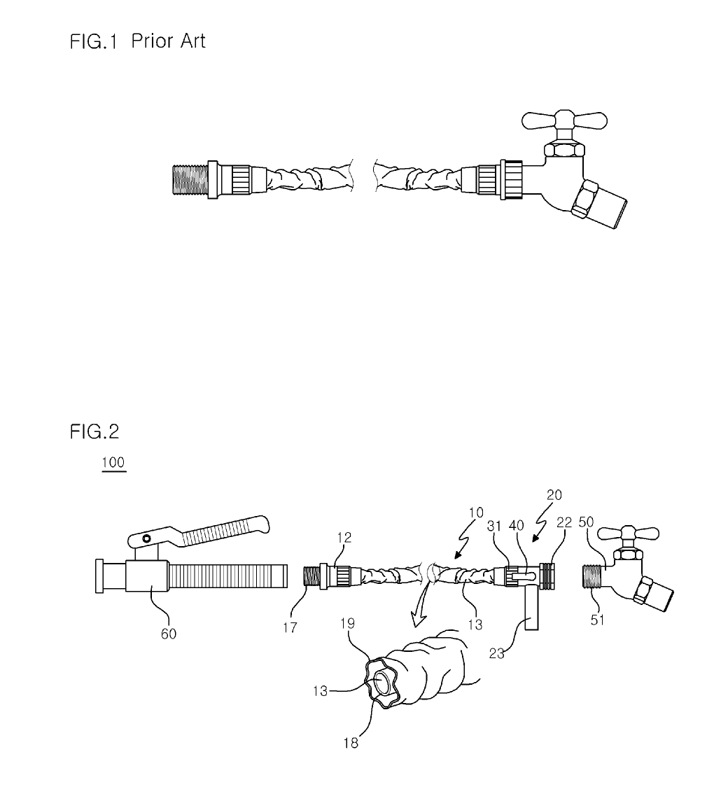

FIG. 1 shows conventional expandable and contractible hoses and the hose includes an elastic inner tube and a non-elastic outer tube.

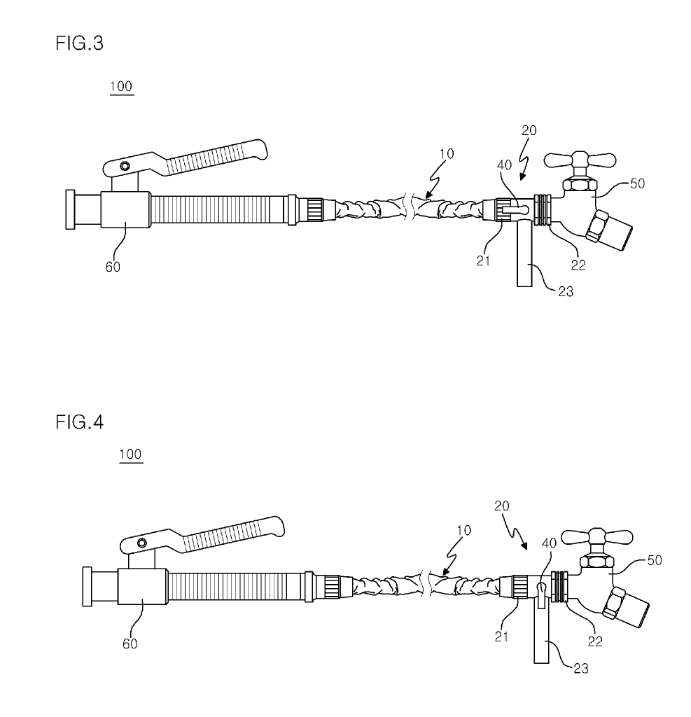

FIG. 2 shows an expandable and contractible hose assembly 100 according to one embodiment of the present invention. FIG. 3 shows the hose assembly 100 of FIG. 2 being attached to a faucet 50 and a spray nozzle 60 and FIG. 4 shows the hose assembly 100 of FIG. 3 with a handle 40 of a three way valve 20 turned.

The expandable and contractible hose assembly 100 includes a hose 10 having a first end 11, a second end 12, and a fluid channel 13 wherein the fluid channel 13 is constructed for transporting a fluid material between the first end 11 and the second end 12; and a three way valve 20 attached to the first end 11 wherein the three way valve 20 has a first port 21, a second port 22, a third port 23 and a handle 40.

The hose 100 is constructed in that the hose 100 longitudinally expands when there is a sufficiently increased fluid pressure in the fluid channel 13 and the hose 100 longitudinally contracts when there is a sufficiently decreased fluid pressure in the fluid channel 13. More preferably, the hose 100 longitudinally substantially expands when there is a sufficiently increased fluid pressure in the fluid channel 13 and the hose 100 longitudinally substantially contracts when there is a sufficiently decreased fluid pressure in the fluid channel 13. In one embodiment, the hose 100 can expand many times its original length.

The first port 21 comprises a first port coupler 31 and the second port 22 comprises a second port coupler 32. The first port coupler 31 is adapted to be fixedly connected to the first end 11 of the hose 10 and the second port coupler 32 is adapted to be releasably connected to a faucet 50.

The first, second, and third ports 21, 22 and 23 are arranged in “T” shape in which the third port 23 is substantially perpendicular to the first and second ports 21 and 22 and the first and second ports 21 and 22 are substantially collinear.

The three way valve 20 has two port connections, a first port connection and a second port connection, and the handle 40 changes port connections between the first port connection and the second port connection. FIGS. 10(a) and 10(b) respectively show the first and second port connections.

The first port connection is defined as a port connection between the first port 21 and the second port 22 so that fluid can flow between the first and second ports 21 and 22 and the second port connection is defined as a port connection between the first port 21 and the third port 23 so that fluid can flow between the first and third ports 21 and 23.

In the first port connection, the three way valve 20 blocks the third port 23 to prevent fluid from flowing to or from the third port 23 whereas in the second port connection, the three way valve 20 blocks the second port 22 to prevent fluid from flowing to or from the second port 22.

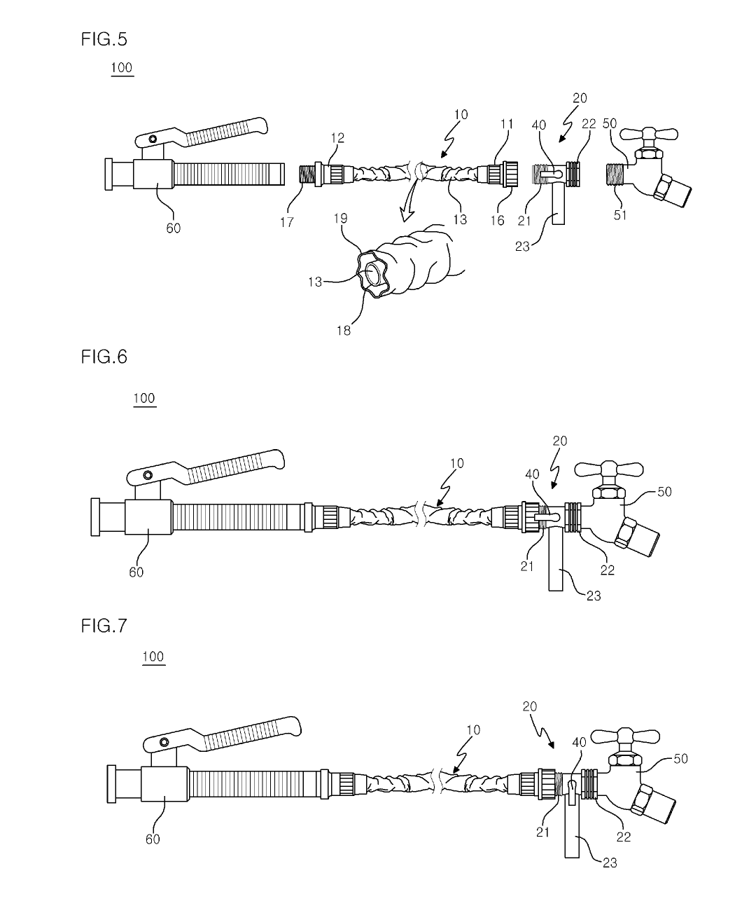

In the first port connection, the handle 40 is substantially parallel to the first port 21 and points to a direction of the first port 21 as shown in FIG. 10(a) or FIG. 6, and in the second port connection, the handle 40 is substantially parallel to the third port 23 and points to a direction of the third port 23 as shown in FIG. 10(b) or FIG. 7. In FIGS. 10(a) and 10(b), the handle 41 is depicted in broken lines.

The third port 23 is preferably downwardly positioned as in FIGS. 6 and 7 so that water can be downwardly discharged or the third port 23 can be easily turned to either side.

FIG. 5 shows the expandable and contractible hose assembly 100 having a hose 10 and a three way valve 20 according to another embodiment of the present invention. The hose assembly 100 is not attached to a spray nozzle 60 or a faucet 50. FIG. 6 shows the hose assembly 100 attached to the spray nozzle 60 and the faucet 50. In addition, FIG. 7 shows the hose assembly of FIG. 6 in which a handle 40 of the three way valve 20 is turned.

The expandable and contractible hose assembly 100 includes a hose 10 having a first end 11, a second end 12, and a fluid channel 13 wherein the fluid channel 13 is constructed for transporting a fluid material between the first end 11 and the second end 12; and a three way valve 20 attached to the first end 11 wherein the three way valve 20 has a first port 21, a second port 22, a third port 23 and a handle 40.

The hose 100 is constructed in that the hose 100 longitudinally expands when there is a sufficiently increased fluid pressure in the fluid channel 13 and the hose 100 longitudinally contracts when there is a sufficiently decreased fluid pressure in the fluid channel 13. More preferably, the hose 100 longitudinally substantially expands when there is a sufficiently increased fluid pressure in the fluid channel 13 and the hose 100 longitudinally substantially contracts when there is a sufficiently decreased fluid pressure in the fluid channel 13. In one embodiment, the hose 100 can expand many times its original length.

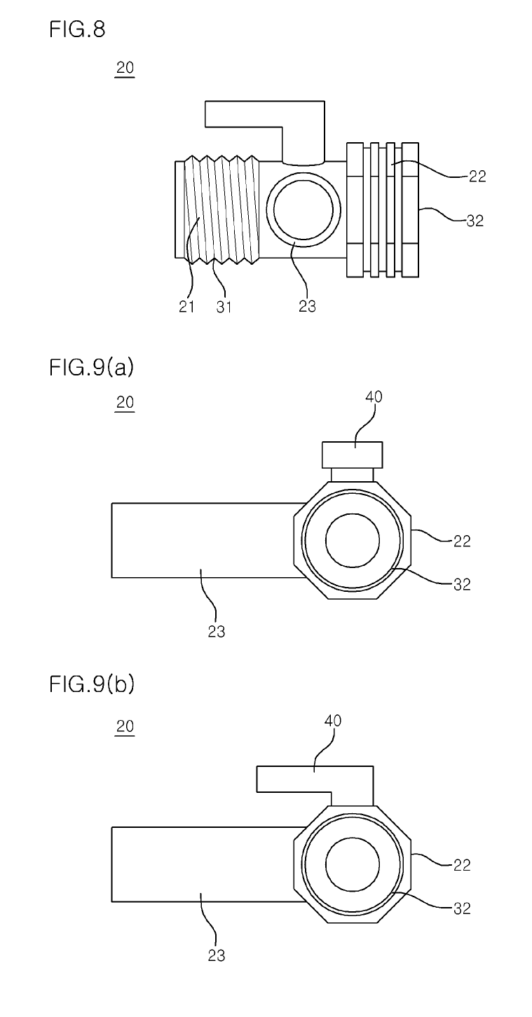

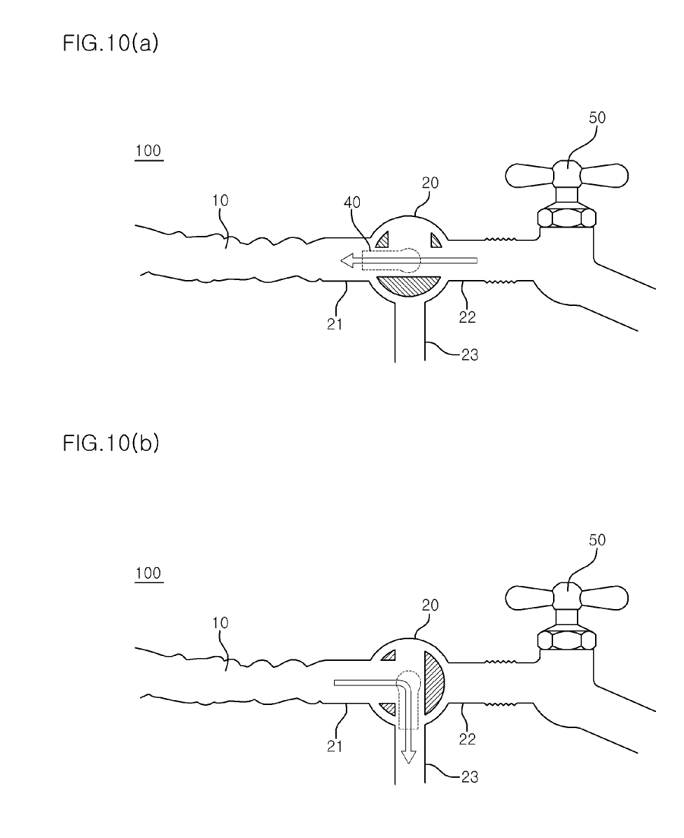

FIG. 8 shows a bottom view of the three way valve 20. FIG. 9(a) shows a side view of the three way valve 20 and FIG. 9(b) shows another side view of the three way valve 20 with the handle 40 turned.

The first, second, and third ports 21, 22 and 23 are arranged in “T” shape in which the third port 23 is substantially perpendicular to the first and second ports 21 and 22 and the first and second ports 21 and 22 are substantially collinear.

The three way valve 20 has two port connections, a first port connection and a second port connection, and the handle 40 changes port connections between the first port connection and the second port connection. FIGS. 10(a) and 10(b) respectively show the first and second port connections.

The first port connection is defined as a port connection between the first port 21 and the second port 22 so that fluid can flow between the first and second ports 21 and 22 and the second port connection is defined as a port connection between the first port 21 and the third port 23 so that fluid can flow between the first and third ports 21 and 23.

In the first port connection, the three way valve 20 blocks the third port 23 to prevent fluid from flowing to or from the third port 23 whereas in the second port connection, the three way valve 20 blocks the second port 22 to prevent fluid from flowing to or from the second port 22.

In the first port connection, the handle 40 is substantially parallel to the first port 21 and points to a direction of the first port 21 as shown in FIG. 10(a) or FIG. 6, and in the second port connection, the handle 40 is substantially parallel to the third port 23 and points to a direction of the third port 23 as shown in FIG. 10(b) or FIG. 7. In FIGS. 10(a) and 10(b), the handle 41 is depicted in broken lines.

The third port 23 is preferably downwardly positioned as in FIGS. 6 and 7 so that water can be downwardly discharged or the third port 23 can be easily turned to either side.

The first port 21 comprises a first port coupler 31 and the second port 22 comprises a second port coupler 32. In addition, the first port coupler 31 is adapted to be releasably connected to the first end 11 of the hose 10 and the second port coupler 32 is adapted to be releasably connected to a faucet 50.

The first end 11 of the hose 10 comprises a first end coupler 16 and the second end 12 of the hose 10 comprises a second end coupler 17. The first end coupler 16 is adapted to be releasably connected to the first port coupler 31.

In one embodiment, the first end coupler 16 has female threads to be mated with male threads of the first port coupler 31. The second port coupler 32 has female threads to be mated 51 with male threads of the faucet 50. The second port coupler 32 may include a gasket to tightly seal the gap between the second port coupler 32 and male threads 51 of the faucet 50.

Besides, the second end coupler 17 is constructed to be releasably connected to a spray nozzle 60 having an on/off valve. The second end coupler 17 has male threads to be mated with female threads of the spray nozzle.

The above stated connections of male/female threads may be vice versa: one having male threads and the other having female threads, or one having female threads and the other having male threads. Alternatively, other connection methods may be used, or some or all of them may be fixedly attached. For example, the three way valve 20 may be fixedly attached to the hose 10.

The expandable and contractible hose assembly 100 may further comprises a discharge hose (not shown) which is releasably connected to the third port 23. The discharge hose provides a route for water in the hose to be discharged therethrough and may lead to a water storage container such as a bucket. Water gathered in the water storage container may be re-used for other purposes such as watering plants or flowers.

The hose 10 comprises an inner tube 18 and an outer tube 19. Preferably, the inner tube 18 is made of an elastic material and the outer tube 19 is made of non-elastic material. The inner tube 18 longitudinally expands when there is a sufficiently increased fluid pressure in the fluid channel 13 and the inner tube 18 longitudinally contracts when there is a sufficiently decreased fluid pressure in the fluid channel 13. In one embodiment, the inner tube 18 expands many times its original length.

In one embodiment, the inner tube 18 is made of a natural latex rubber and the outer tube 19 is made of fabric.

FIG. 10(a) shows a schematic diagram showing water flow when the hose 10 is in use, and FIG. 10(b) shows a schematic diagram showing water flow when water in the hose 10 is discharged after using the hose 10.

When the hose 10 is in use, the faucet 50 is open and the handle 40 of the three way valve 20 is turned for the first port connection as shown in FIG. 10(a). Water flows to the second port 22, to the first port 21, to the hose 10, and then to the spray nozzle 60. Once the on/off valve of the spray nozzle 60 turns off, water pressure inside the tube 10 increases and then, because of the increased pressure, the hose 10 substantially expands. The hose 10 can expand up to many times its original length.

After using the hose 10, the on/off valve of the spray nozzle 60 is turned off and the handle 40 of the three way valve 20 is turned for the second port connection as shown in FIG. 10(b). Then, because of the water pressure inside the hose 10, water remaining in the hose 10 begins to flow to the first port 21 and then, to the third port 23, and then, the water is discharged. While the water is being discharged, the hose contracts to its original size.

In this way, the water in the hose 10 does not splash, but is automatically discharged in the orderly manner.

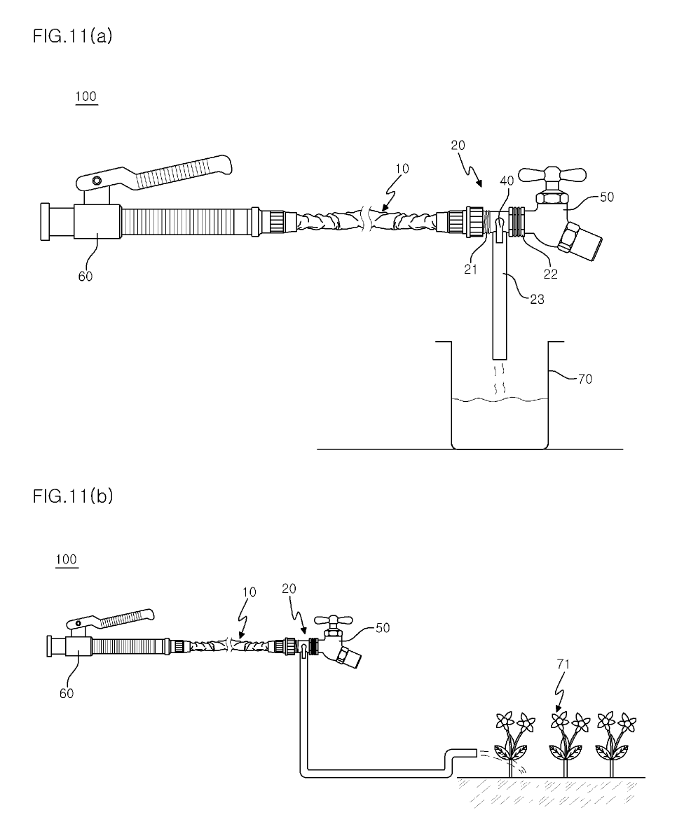

FIGS. 11(a) and 11(b) show the expandable and contractible hose assembly 100 of the present invention discharging water respectively to a watering can 70 and to a flower bed 71. In this way, the water in the hose 10 can be discharged and recycled.

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. An expandable and contractible hose assembly, comprising:
a hose having a first end, a second end, and a fluid channel wherein the fluid channel is constructed for transporting a fluid material between the first end and the second end; and
a three way valve attached to the first end wherein the three way valve has a first port, a second port, a third port and a handle;
wherein the hose is constructed in that the hose longitudinally expands when there is a sufficiently increased, fluid pressure in the fluid channel and the hose longitudinally contracts when there is a sufficiently decreased fluid pressure in the fluid channel,
wherein the first port comprises a first port coupler and the second port comprises a second port coupler, and
wherein the first port coupler is adapted to be fixedly connected to the first end of the hose and the second port coupler is adapted to be releasably connected to a faucet.

2. The expandable and contractible hose assembly of claim 1, wherein the first, second, and third ports are arranged in “T” shape wherein the third port is substantially perpendicular to the first and second ports and the first and second ports are substantially collinear.

3. The expandable and contractible hose assembly of claim 2, wherein the three way valve has two port connections, a first port connection and a second port connection, and the handle changes port connections between the first port connection and the second port connection.

4. The expandable and contractible hose assembly of claim 3, wherein the first port connection is defined as a port connection between the first port and the second port so that fluid can flow between the first and second ports and the second port connection is defined as a port connection between the first port and the third port so that fluid can flow between the first and third ports,
wherein in the first port connection, the three way valve blocks the third port to prevent fluid from flowing to or from the third port, and in the second port connection, the three way valve blocks the second port to prevent fluid from flowing to or from the second port.

5. The expandable and contractible hose assembly of claim 4, wherein in the first port connection, the handle is substantially parallel to the first port and points to a direction of the first port, and
wherein in the second port connection, the handle is substantially parallel to the third port and points to a direction of the third port.

6. The expandable and contractible hose assembly of claim 4, wherein the third port is downwardly positioned.

7. An expandable and contractible hose assembly, comprising:
a hose having a first end, a second end, and a fluid channel wherein the fluid channel is constructed for transporting a fluid material between the first end and the second end; and
a three way valve attached to the first end wherein the three way valve has a first port, a second port, a third port and a handle;
wherein the hose is constructed in that the hose longitudinally expands when there is a sufficiently increased fluid pressure in the fluid channel and the hose longitudinally contracts when there is a sufficiently decreased fluid pressure in the fluid channel.

8. The expandable and contractible hose assembly of claim 7, wherein the first, second, and third ports are arranged in “T” shape wherein the third port is substantially perpendicular to the first and second ports and the first and second ports are substantially collinear.

9. The expandable and contractible hose assembly of claim 8, wherein the three way valve has two port connections, a first port connection and a second port connection, and the handle changes port connections between the first port connection and the second port connection.

10. The expandable and contractible hose assembly of claim 9, wherein the first port connection is defined as a port connection between the first port and the second port so that fluid can flow between the first and second ports and the second port connection is defined as a port connection between the first port and the third port so that fluid can flow between the first and third ports,
wherein in the first port connection, the three way valve blocks the third port to prevent fluid from flowing to or from the third port, and in the second port connection, the three way valve blocks the second port to prevent fluid from flowing to or from the second port.

11. The expandable and contractible hose assembly of claim 10, wherein in the first port connection, the handle is substantially parallel to the first port and points to a direction of the first port, and
wherein in the second port connection, the handle is substantially parallel to the third port and points to a direction of the third port.

12. The expandable and contractible hose assembly of claim 10, wherein the third port is downwardly positioned.

13. The expandable and contractible hose assembly of claim 7, wherein the first port comprises a first port coupler and the second port comprises a second port coupler.

14. The expandable and contractible hose assembly of claim 13, wherein the first port coupler is adapted to be releasably connected to the first end of the hose and the second port coupler is adapted to be releasably connected to a faucet.

15. The expandable and contractible hose assembly of claim 13, wherein the first end of the hose comprises a first end coupler and the second end of the hose comprises a second end coupler,
wherein the first end coupler is adapted to be releasably connected to the first port coupler.

16. The expandable and contractible hose assembly of claim 15, wherein the second end coupler is constructed to be releasably connected to a spray nozzle having an on/off valve.

17. The expandable and contractible hose assembly of claim 7, further comprising a discharge hose which is releasably connected to the third port.

18. The expandable and contractible hose assembly of claim 7, wherein the hose comprises an inner tube and an outer tube,
wherein the inner tube is made of an elastic material and the outer tube is made of non-elastic material, and
wherein the inner tube longitudinally expands when there is a sufficiently increased fluid pressure in the fluid channel and the inner tube longitudinally contracts when there is a sufficiently decreased fluid pressure in the fluid channel.

19. The expandable and contractible hose assembly of claim 18, wherein the inner tube is made of a natural latex rubber and the outer tube is made of fabric.
